(19) United States
(12) Patent Application Publication
(10) Pub. No.: US 2007/0179961 A1
(43) Pub. Date: Aug. 2, 2007

(54) HIERARCHICAL STORAGE

(76) Inventor: Fabio GAVA, Ladera Ranch, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/679,014

(22) Filed: Feb. 26, 2007

Related U.S. Application Data
(63) Continuation-in-part of application No. 10/156,345, filed on Jul. 15, 2002, now abandoned.

(51) Int. Cl. G06F 7/00

(52) U.S. Cl. 707/100

(57) ABSTRACT

A system and method is provided for implementing hierarchical storage of information. The system comprises a hierarchical repository having at least two levels. The first level comprises a folder and a markup language based file within the folder for storing information. Also stored within the folder is a second level folder which also has a markup language based file stored within the folder. In order to access the repository, a user interface is provided.

### CROSS-REFERENCE TO RELATED APPLICATIONS

This Application is a Continuation-in-Part of U.S. patent application Ser. No. 10/156,345, filed Jul. 15, 2002, the entirety of which is incorporated herein.

### BACKGROUND OF THE INVENTION

This invention pertains generally to information management, and more particularly to a hierarchical storage system for managing information.

In the Microsoft Windows family of operating systems (“OS”), beginning with Windows 95, the operating system implements a registry, which acts is a single location for storing information. Such information suitably includes OS-dependent system settings, such as hardware information, selected system options, computer memory configuration, application program information, peripheral device information, system policy information, etc. In a network environment, for example, registry information on a server can be managed centrally and can be used to store system policies for individuals and workgroups.

The Windows registry has a hierarchical structure to facilitate management of the various types of information stored within the registry. The hierarchical structure creates an organized information set. Other OS, however, do not use a hierarchical organizational structure for saving information. Therefore, developers are forced to use other methods of storing information when developing for non-Windows platforms. In such instances, developers may use plain text files, either stored in a single location or scattered throughout a file system, to store information relating to a developed program.

For example, when developing embedded system software for controlling configurable digital imaging devices (“DID”) storage for configuration parameters must be provided. In the Windows environment, configuration parameters are stored in the registry. In the Linux environment, however, configuration parameters are stored in text-based configuration files. Consequently, configurable DIDs are generally dependent on an OS to receive configuration information. Therefore, when OS configuration settings change, new software must be written, compiled, provided to customers, and installed. It would be preferable if the software were platform independent such that a single version of a DID software program could accommodate multiple OS. Therefore, it would preferable if DID software programs accessed configuration parameters stored independently of such OS-specific configuration.

One method of implementing a OS-independent information storage is to implement a markup language based file having a plurality of sections for storing information. For example, accessing data stored in an extensible markup language (“XML”) file is suitably accomplished through the use of an XML parser that is Document Object Model (“DOM”) compliant. XML is a universal syntax for describing and structuring data independent from application logic. XML can be used to define unlimited languages for specific industries and applications. XML is a text-based syntax that is readable by both computer and humans which offers data portability and reusability across different platforms and devices. The DOM is a platform- and language-neutral interface that allows programs and scripts to dynamically access and update the content, structure and style of documents. The document can be further processed and the results of that processing can be incorporated back into the presented page.

DOM compliant parsers read an entire XML file and create in memory a tree structure that mirrors the hierarchical nature of the data. The content of the XML document is accessible through a root element, whose attributes, contents and sub-elements can be inspected. Given the names of a sequence of nested XML elements, it is possible to reach any contained element, its attributes and content, by traversing the tree beginning from the root element and following the given sequence of element names. It is also possible to promote changes both on the structure and contained information, by adding, deleting or changing elements and its data. Therefore, an XML based repository allows for hierarchical structure while maintaining cross-platform functionality.

Using an XML file to implement information storage can be problematic because once an XML file is loaded into a process memory address space, changing the memory content does not guarantee persistency. Consequently, any change made to a memory space must be rewritten back to the XML document to maintain persistency. When the XML file is a large document, this becomes a cumbersome and relatively time intensive task. It would be preferable if there were a more efficient cross-platform storage system.

### SUMMARY OF THE INVENTION

In accordance with the present application, there is provided a hierarchical information storage system. The storage system comprises a hierarchical repository which has at least one first level folder for storing at least first and second data sets and at least one first level markup based file stored within the at least one first level folder, the first level markup based file storing information relative to at least a portion of the first data set. The repository also comprises at least one second level folder stored within the at least one first level folder. The second level folder stores information relative to the second data set. Within the second level folder is at least one second level markup based file. The second level markup based file comprises information relative to at least a portion of the second data set. In addition, the hierarchical information storage system comprises an interface communicatively coupled to the repository for handling communications with the repository, the interface comprising computer readable code on a computer readable medium.

Further in accordance with one embodiment of the subject application, there is provided a multi-level, hierarchical information configuration data storage system employing a markup language linked to a corresponding file system. The system includes a file system based configuration data repository, which includes at least one first level folder, represented by a first selected directory area of the file system, for storing at least first and second data sets inclusive of configuration information for an associated document imaging device. The file system based configuration data repository also includes at least one first level markup based data file stored within the first level folder, with the first level markup based data file linked to the first selected directory area and comprising information relative to a portion of the first data set. In addition, the file system based configuration data repository comprises at least one second level folder, represented by a second selected directory area of the file system, and stored within the first level folder for storing information relative to the second data set. The file system based configuration data repository further includes at least one second level markup based data file stored within the second level folder, wherein the second level markup based data file is linked to the second selected directory area and comprising information relative to at least a portion of the second data set. The data storage system further includes an interface communicatively coupled to the repository for handling communications with the repository. The interface includes means adapted for outputting the configuration information from the file system to a data format compatible with one of a plurality of different operating systems, means adapted for selectively locking at least one selected directory area during a modification of a data set corresponding thereto, and means adapted for communicating output configuration information to a selected one of a plurality of different operating system environments, including an operating system employing hierarchical configuration information storage and an operating system including non-hierarchical configuration information storage.

In accordance with one embodiment of the subject application, there is provided a multi-level hierarchical device configuration information storage system in a network environment. The storage system includes a client communicatively coupled to a server, a file system based configuration repository stored on the server, and an interface communicatively coupled to the repository for handling communications with the repository. The repository includes at least one first level folder for storing at least first and second data sets inclusive of configuration information for an associated document processing device. The repository also includes at least one first level markup based file stored within the at least one first level folder, the first level markup based file comprising information relative to at least a portion of the first data set. In addition, the repository comprises at least one second level folder stored within the at least one first level folder for storing information relative to the second data set, and at least one second level markup based file stored within the at least one second level folder, the second level markup based file comprising information relative to at least a portion of the second data set. The interface of the system includes means adapted for outputting the configuration information from the file system to a data format compatible with one of a plurality of different operating systems, means adapted for selectively locking at least one selected directory area during a modification of a data set corresponding thereto and means adapted for communicating output configuration information to a selected one of a plurality of different operating system environments, including an operating system employing hierarchical configuration information storage and an operating system including non-hierarchical configuration information storage.

Still further, in accordance with one embodiment of the subject application, there is provided a method for accessing device configuration data from a repository in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE FIGURES

FIG. 1 is a representation of a multi-level, hierarchical information configuration data storage system employing a markup language linked to a corresponding file system according to one embodiment of the subject invention;

FIGS. 2A-B are representations of a hierarchical markup language based information storage file;

FIG. 3A is a representation of the structure of a hierarchical storage system according to the present invention;

FIG. 3B is a representation of a hierarchical storage system for storing information contained in the hierarchical repository file of FIG. 2B;

FIGS. 4A-D are representations of a plurality of files in the hierarchical storage system of FIG. 3B;

FIG. 5 is an illustration of one embodiment of a system in a network environment according to one example embodiment of the subject application;

FIG. 6 is a flowchart generally depicting a method for interfacing with the hierarchical storage system of the present invention;

FIG. 7A is a flowchart generally depicting a method for creating elements in the hierarchical storage system of the present invention; and

FIG. 7B is a flowchart generally depicting a method for creating elements in a hierarchical markup language file.

### DETAILED DESCRIPTION OF THE INVENTION

The subject application is directed to a multi-level, hierarchical information configuration data storage system and method employing a markup language linked to a corresponding file system. In particular, the subject application is directed to a multi-level hierarchical device configuration information storage system and method in a network environment. It will become apparent to those skilled in the art that the system and method described herein are suitably adapted to a plurality of varying electronic fields employing hierarchical information configuration data storage, including, for example and without limitation, communications, general computing, data processing, document processing, or the like. The preferred embodiment, illustrates a document processing field for example purposes only and is not a limitation of the subject application solely to such a field.

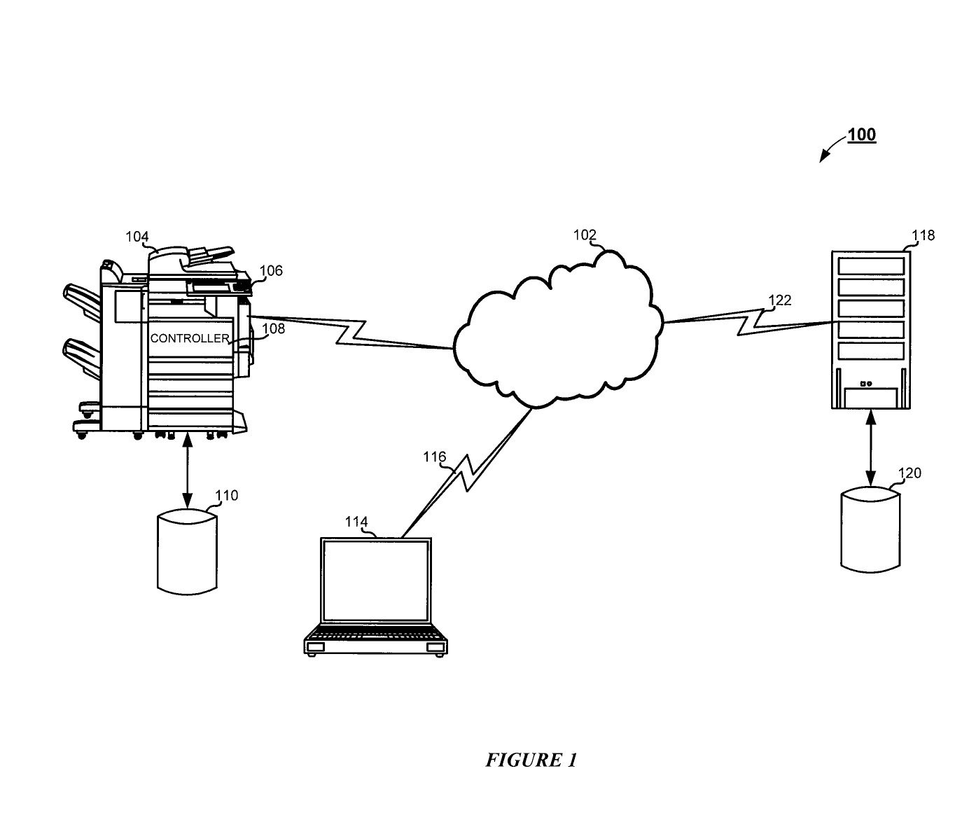

Referring now to FIG. 1, there is shown an overall diagram of a multi-level hierarchical device configuration information storage system 100 in a network environment in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a digital imaging device (“DID”) 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available DIDs include, for example and without limitation, the Toshiba e-Studio Series Controller. In accordance with one aspect of the subject application, the DID 104 is suitably adapted to provide remote document processing services to external or network devices. Preferably, the DID 104 includes hardware, software, and any suitable combination thereof, configured to interact with an associated user, a networked device, or the like.

According to one embodiment of the subject application, the DID 104 is suitably equipped to receive a plurality of portable storage media, including, without limitation, Firewire drive, USB drive, SD, MMC, XD, Compact Flash, Memory Stick, and the like. In the preferred embodiment of the subject application, the DID 104 further includes an associated user interface 106, such as a touch-screen, LCD display, touch-panel, alpha-numeric keypad, or the like, via which an associated user is able to interact directly with the DID 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the DID 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

In accordance with one embodiment of the subject application, the DID 104 further incorporates a backend component, designated as the controller 108, suitably adapted to facilitate the operations of the DID 104, as will be understood by those skilled in the art. Preferably, the controller 108 is embodied as hardware, software, or any suitable combination thereof, configured to control the operations of the associated DID 104, facilitate the display of images via the user interface 106, direct the manipulation of electronic image data, and the like. For purposes of explanation, the controller 108 is used to refer to any myriad of components associated with the DID 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for hierarchical storage of the subject application.

Communicatively coupled to the DID 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the DID 104, a component of the controller 108, or the like, such as, for example and without limitation, an internal hard disk drive, or the like. In accordance with one embodiment of the subject application, the data storage device 110 is capable of storing configuration information in a platform-independent format corresponding to the functioning of the associated DID 104.

The system 100 illustrated in FIG. 1 further depicts a client device 114, in data communication with the computer network 102 via a communications link 116. It will be appreciated by those skilled in the art that the client device 114 is shown in FIG. 1 as a laptop computer for illustration purposes only. As will be understood by those skilled in the art, the client device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the client device 114 is suitably adapted to generate and transmit electronic documents, document processing instructions, user interface modifications, upgrades, updates, personalization data, or the like, to the DID 104, or any other similar device coupled to the computer network 102. According to the preferred embodiment of the subject application, the client device 114 employs a non-hierarchical configuration information storage.

The system 100 further includes a server 118, in data communication with the computer network 102 via a suitable communications link 122. In accordance with the preferred embodiment of the subject application, the server 118 is coupled to a file system based configuration data repository, represented in FIG. 1 as the data storage device 120. The repository includes a first level folder, represented by a first directory area, which stores first and second data sets inclusive of configuration information for an associated document imaging device, e.g., the DID 104. In addition, the repository 120 also includes a first level markup based data file within the first level folder, which is linked to the first selected directory area and includes information relative to a portion of the first data set. The repository further includes a second level folder, represented by a second directory area, within the first level folder for storing information relative to the second data set, as well as a second level markup based data file within the one second level folder. Preferably, the second level markup based data file is linked to the second directory area and includes information relative to a portion of the second data set.

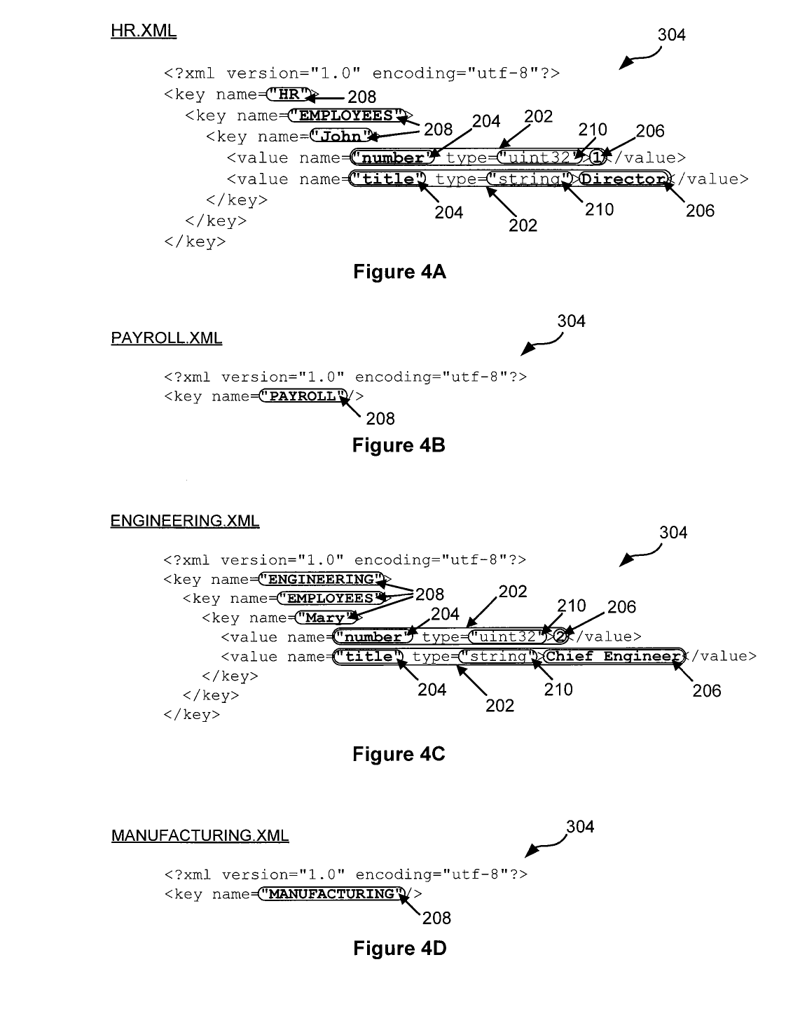

In accordance with one particular embodiment of the subject application, the server 118 further includes an interface component (not visible, see FIG. 4), coupled to the repository 120 to facilitate communications with the repository. Preferably, the interface is capable of outputting configuration information from the repository in a data format compatible with different operating systems. According to another embodiment, the interface is also capable of locking a selected directory area during modification of a corresponding data set, so as to prevent further modifications thereto. Via the server 118, the interface is adapted for communicating the output configuration information to a variety of different operating system environments. For example, the interface is capable of outputting configuration information to an operating system employing a hierarchical configuration information storage, e.g., the DID 104, as well as an operating system environment employing non-hierarchical configuration information storage, e.g., the client device 114. Application of the foregoing system will be better understood in conjunction with the example embodiments of the subject application, described greater detail below.

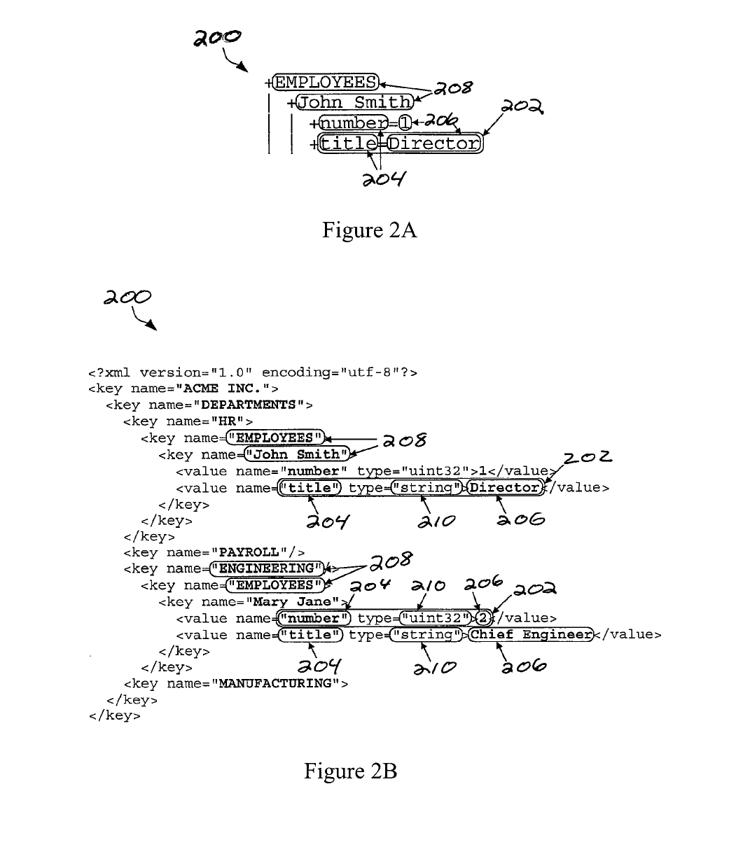

Turning now to FIG. 2A, an illustration of the general structure of a hierarchical markup language based configuration information storage file 200 is disclosed. As shown, the information storage file 200 suitably stores pairs 202 of storage names 204 and values 206. The name 204 and value 206 pairs 202 are suitably grouped according to the information to which they correspond and are preferably grouped in keys 208. The skilled artisan will appreciate that the information contained in the configuration information file 200 is representative of configuration information for establishing a hierarchical structure, as set forth below. It will be understood by those skilled in the art that the use of employment data is for illustration purposes only, and other applications are equally capable of implementation including, for example and without limitation, device configuration settings, so as to configure devices independent of the operating system running on such devices.

Turning now to FIG. 2B, an illustration of a portion of an example hierarchical markup language based configuration information storage file 200 is disclosed. The organizational structure of configuration information storage file 200 is suitably the same as the structure shown in FIG. 2A. The configuration information storage file 200 is suitably a markup language based file, such as HTML, SGML, or XML, although any markup language is suitably used as will be appreciated by those skilled in the art. In the presently preferred embodiment, the configuration information storage file 200 is an XML file. XML offers data portability and reusability across different platforms and devices. It is also flexible and extensible, allowing new tags to be added without breaking an existing document structure. Based on Unicode, XML provides global language support.

Markup suitably describes and structures content, by using various XML structures, such as element types, attributes, entity references, character data (“CDATA”) sections and document type declarations. It can comply with the pre-defined grammar of document type definitions (“DTD”) or can be defined as the document instance is created. Markup is any part of the document instance that starts with “<” or “&”. It describes content, but is not read as character data, it is the actual content of the document.

The configuration information storage file 200 suitably stores name and value pairs 202. The name 204 and value 206 pairs 202 are suitably grouped according to the information they store and preferably grouped in keys 208. Furthermore, keys 208 are suitably grouped under other keys 208, creating a multi-level organizational structure. Name and value pairs 202 are preferably grouped in a key 208 and comprise stored information. Keys 208 preferably provide the organizational structure of the stored information. The name 204 preferably defines the information stored and the value 206 preferably stores the information. For example, a name 204 and value 206 pair 208 suitably consists of “title” and “Director”. The name 204 is “title” and the value 206 is “Director”. In other words, the “title” is “Chief Engineer”. In this manner, a name 204 functions as does a field in a database and a value 206 functions as does the data stored in the field.

In addition, for each value, there preferably comprises a type 210. In the presently preferred embodiment, the type is either string, unsigned integer, or binary, although it will be understood by those skilled in the art that other data storage types are suitably used. The type 210 preferably defines the type of information stored in the value 206. In the case where the name 204 is “title” and the value 206 is “Director”, the type 210 is suitably “string”.

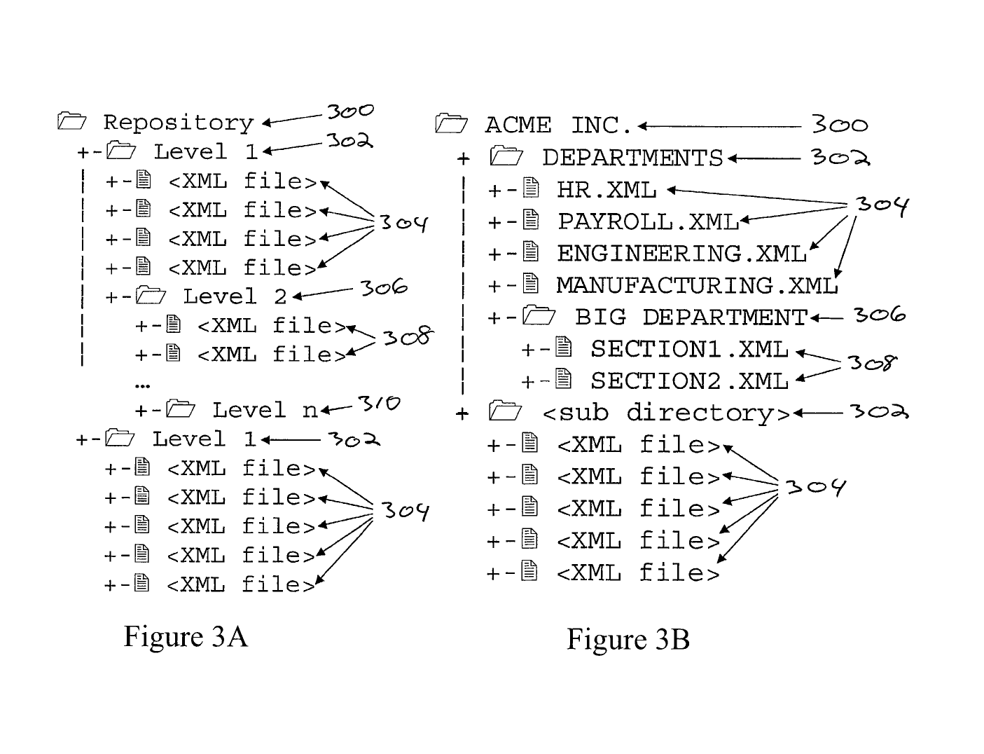

Turning now to FIGS. 3A-B, FIG. 3A discloses the general structure of the hierarchical information storage system according to the present invention and FIG. 3B discloses the hierarchical information storage system as applied to the file of FIG. 2B. The information storage system 200 is suitably a repository 300 comprising a plurality of levels. The repository preferably comprises a first storage level. The first storage level preferably comprises at least one storage container. In the presently preferred embodiment, the storage container is a first level folder 302. The first level folder 302 is suitably a folder at any level other than the bottommost level of the repository 300. Stored within the first level folder 302 is preferably at least one first level markup based file 304. In the presently preferred embodiment, the markup based file is an XML file, although HTML, SGML, or any other markup language is suitably used, as will be appreciated by those skilled in the art.

Also stored within the at least one first level folder 302 is at least one second level folder 306. The second level folder 306 is suitably a folder at any level other than the topmost level of the repository 300. Like the first level folder 302, at least one first level markup based file 308 is preferably stored within the at least one second level folder 306. In the presently preferred embodiment, the markup based file is an XML file, although HTML, SGML, or any other markup language is suitably used, as will be appreciated by those skilled in the art. In addition to the at least one markup based file 308, the second level folder suitably comprises at least one lower level folder 310, which in turn comprises additional files, which are suitably files of any type. In addition, the lower level folder 310 suitably comprises at least one additional folder. Each folder in the repository 300 preferably comprises at least one markup language based file.

Turning now to FIGS. 4A-D, representations of a plurality of markup language based files disclosed in the hierarchical storage system of FIG. 3B. Like the file represented in FIGS. 2A-B, the files represented in FIGS. 4A-D are preferably markup based files that store pairs 202 of storage names 204 and values 206. The name 204 and value 206 pairs 202 are suitably grouped according to the information to which they correspond and are preferably grouped in keys 208.

Turning now to FIGS. 4A and 4C, illustrations of portions of exemplary first level markup based files 304 are disclosed. While only first level markup based files 304 are shown, the structure of the markup based files on all levels is preferably the same as that shown for the first level markup based files 304. The first level markup based file 304 is suitably any markup language based file, such as HTML, SGML, or XML, although any markup language is suitably used as will be appreciated by those skilled in the art. In the presently preferred embodiment, the first level markup based file 304 is an XML file. The first level markup based file 304 suitably stores name and value pairs 202. The name and value pairs 202 are suitably grouped according to the information they store and preferably grouped in keys 208. Furthermore, keys 208 are suitably grouped under name and value pairs 202, names 204, values 206, or other keys 208, creating a multi-level organizational structure. FIGS. 4A and 4C show two similarly structured XML files, each with a plurality of keys 208. Each key 208 is suitably a level of organization. As shown in FIG. 4A, for example, the first key 208 or level of organization is “HR”, which is an abbreviation for “human resources” and represents the human resources department of an organization. Within the HR department of an organization are employees, which are categorized by the “EMPLOYEES” key 208 nested under the “HR” key 208. The organization of nested keys 208 preferably provides a hierarchical structure within the markup based file 204. In this manner, each key 208 nested under another key 208 is analogous to a subfolder stored within a folder. Each employee in the HR department has a name. Therefore, nested under the “EMPLOYEES” key 208 is another key 208 “JOHN”, which represents the name of an employee.

Name 204 and value 206 pairs 202 are preferably grouped in a key 208 and comprise stored information. Still referring to FIG. 4A, name 204 and value 206 pairs 202 are nested under the key 208 “JOHN”. The name 204 preferably defines the information stored and the value 206 preferably stores the information. In this manner, a name 204 suitably functions as does a field in a database and a value 206 functions as does the data stored in the field. In the first pair 202, the name 204 is “number” and value 206 is “1”. Therefore, John is employee number 1. Similarly, in the second pair 202, the name 204 is “title” and value 206 is “Director”. Therefore, John's title is Director. In addition, for each value, there preferably comprises a type 210. In the presently preferred embodiment, the type is either string, unsigned integer, or binary, although it will be understood by those skilled in the art that other data storage types are suitably used. The type 210 preferably defines the type of information stored in the value 206. In the case where the name 204 is “number” and value 206 is “1”, the type is suitably unsigned integer, as represented by “uint32”, and in the case where the name 204 is “title” and the value 206 is “Director”, the type 210 is suitably “string”.

Turning now to FIGS. 4B and 4D, illustrations of portions of exemplary first level markup based files 304 are disclosed. Unlike those files illustrated in FIGS. 4A and 4C, the files do not contain any name 204 and value 206 pairs 202. In other words, files resembling those illustrated in FIGS. 4B and 4D act as empty storage units. For example, no employees are listed in FIG. 4B. If one were to add an employee, one would first suitably add a nested key such as “EMPLOYEES” under the “PAYROLL” key 208. One would then add a nested key with an employee name under the “EMPLOYEES” key. Name and value pairs nested under the employee name key are then suitably used to store information about the employee.

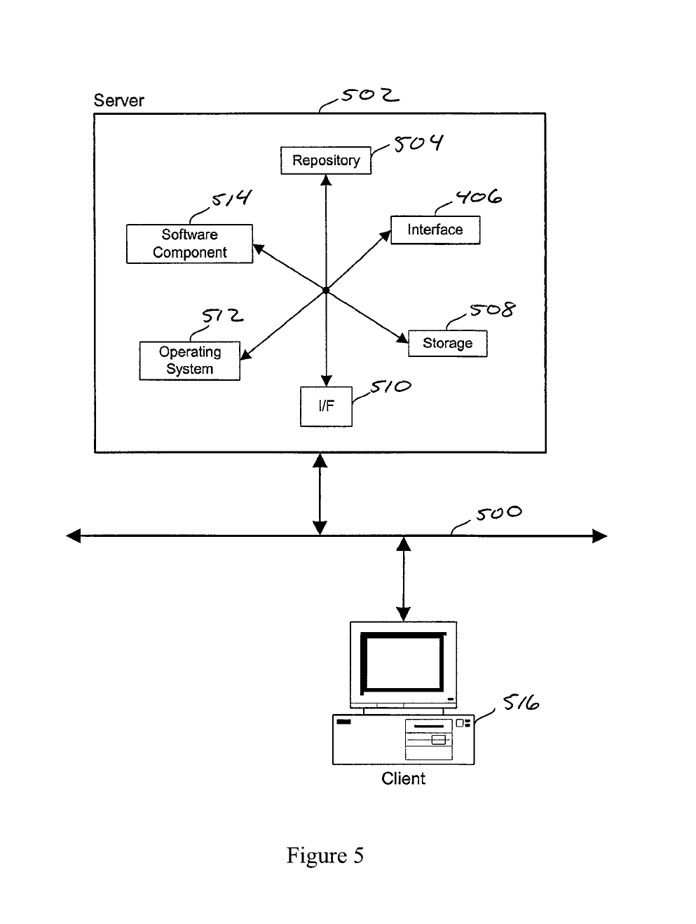

Turning now to FIG. 5, a system diagram illustrating an example embodiment of a hierarchical storage system in a network environment in accordance with the subject application is provided. The system is preferably configurable for use in any network environment, whether peer-to-peer, client-server, or N-tier, and is suitably configurable to accommodate a plurality of users. The system comprises a data transport network 500 illustrative of a LAN or WAN environment in which a preferred embodiment is provided, such as a packet-switched TCP/IP-based global communication network. The network 500 is suitably any network and is preferably comprised of physical layers and transport layers, as illustrated by a myriad of conventional data transport mechanisms like Ethernet, Token-Ring™, 802.11(b), or other wire-based or wireless data communication mechanisms as will be apparent to one of ordinary skill in the art.

Placed in data communication with data transport system 500 is a Server 502 which is suitably any Server for accommodating selective query support, selective data access, data archiving, and the like, as will be appreciated to one of ordinary skill in the art. One or more Clients, such as representative Client 516, is also placed, or selectively placed, in data communication with the data transport system 500. The Client 516 is preferably configured to interact with Server 502 as will be appreciated by one who is skilled in the art. It should be noted that the Client 516 is suitably a Thick Client or a Thin Client, additional server(s), personal digital assistant (“PDA”), or any equipment capable of interacting with Server 502 to send and receive data. Thus, a data path between Server 502 and the one or more Clients, such as representative Client 516, are in shared data communication.

The present invention preferably comprises at least one repository 504, at least one interface 506 and at least one SC 514. It will be appreciated by those skilled in the art that any of the repository 504, interface 506 and SC 514 are suitably storable on the Server 502 or the Client 516 without departing from the scope of the present invention. Therefore, FIG. 5 is simply one possible configuration of the present invention in a network environment. In addition, the present invention is also suitably functional in a stand-alone environment. All components of the present invention would therefore reside on a single machine.

As shown, the Server 502 preferably comprises a network interface 510 through which the Server 502 interfaces with data transport system 500. The Server 502 also preferably comprises internal storage 508, which is suitably in the form of RAM and is suitably embodied as a hard disk, optical storage, removable memory, flash memory, or any other preferably rewritable storage as will be appreciated by those skilled in the art. Preferably stored on internal storage 508 are an operating system 512, a repository 504, an interface 506, and a software component (“SC”) 514. The interface 506 and SC 514 are suitably embodied as computer readable code on a computer readable medium. In the presently preferred embodiment, the software component 514 is a compiled C++ SC. The operating system 512 is suitably any operating system, such as Windows NT, Windows 2000, Windows XP, Unix, Linux, Macintosh or other operating system. The operating system 512 preferably acts as a network operating system and supports client-server network architecture.

The Client 516 is suitably either a Server or Client running any operating system, such as Windows NT, Windows 2000, Windows XP, Unix, Linux, Macintosh or other operating system. In addition, the Client 516 is suitably a Thick Client or Thin Client, as will be appreciated by those skilled in the art.

In the presently preferred embodiment, a user calls functionality of a SC 514. It should be noted that the term “user” should be limited to a human user. A user is suitably anything capable of triggering a call to a software component, such as a computer-readable code used during automation.

A software component 514 then preferably interacts with interface 506, which handles communications with the repository 504. For example, an interface 506 definition and a shared library are linked to a software component 514, which accesses the repository 504. A fixed location for the repository 504 files is suitably established using an operating system environment variable to provide flexibility. It should be noted that all functionality embodied in the SC 514 is alternatively built into the interface 506, thereby obviating the SC 514. The interface 506 suitably comprises functionality for querying the repository 504 structure, changing the repository 504 structure, adding folders to the repository 504, and deleting folders from the repository 504. In addition, the interface 506 also suitably comprises functionality for querying the markup based files, changing the markup based files, adding to the markup based files, and deleting from the markup based files. Furthermore, the interface 506 suitably comprises functionality for ensuring data integrity.

The SC 514 is suitably computer-readable code written in any language. The SC 514 is preferably compiled, pre-written code that defines interfaces that is callable to provide the functionality that the SC 514 encapsulates. SCs are typically packaged in “industry standard” ways such that they are callable from multiple languages, or from multiple environments. The computer-readable code, in the case of SCs is suitably a unit of independent deployment that has no persistent state. As such, it provides seamless integration with existing development tools, such Forte for Java or Microsoft Visual Studio. SCs are suitably used out-of-the-box, or extended and specialized by developers as desired. It should be noted that the SCs of the present invention are suitably designed for any language binding, such as Common Object Request Broker Architecture (“CORBA”), NET, COM, DCOM, C++, ActiveX, etc., as will be appreciated by those skilled in the art. In the presently preferred embodiment, the SC 514 is a C++ SC that is callable from multiple languages, or from multiple environments, or operating systems.

The SC 514 of the present invention suitably comprises functionality for interacting with an element (folder, file, etc.) of the repository 504, such as querying, creating, modifying, and deleting. Furthermore, the SC 514 suitably comprises functionality for performing a function on a key 208, or on name 204 and value 206 pairs 202 of markup based files in the repository 504. Such functionality suitably comprises querying, creating, modifying, and deleting. Table 1 provides a list of example functions callable through SC 514.

TABLE 1
Software Component Functions

| Method | Parameters | Description |
|---|---|---|
| GetValue | string specifying value path | Returns on the string object |
| | string object to hold value | the specified value. |
| GetValue | string specifying value path | Returns on the unsigned int |
| | unsigned integer to hold value | the specified value. |
| GetValue | string specifying value path | Returns on the buffer the |
| | buffer to hold binary value | specified binary value. |
| | buffer size | |
| SetValue | string specifying value path | Sets the specified string |
| | string value | value or creates it if it |
| | | does not exist. |
| SetValue | string specifying value path | Sets the specified unsigned |
| | unsigned integer value | integer value or creates it |
| | | if it does not exist. |
| Set Value | string specifying value path | Sets the specified binary |
| | buffer with binary value | value or creates it if it |
| | buffer size | does not exist. |
| Enumerate | string specifying a key path | Enumerates the sub keys of |
| Keys | an object to hold the list of | the specified key. |
| | keys retrieved | |
| Enumerate | string specifying a key path | Enumerates the values con- |
| Values | an object to hold the list of | tained by the specified key. |
| | values retrieved | |
| DeleteValue | string specifying value path | Deletes specified value. |
| DeleteKey | string specifying key path | Deletes the last key in the |
| | | specified path. |

The path referenced in Table 1 is suitably a concatenation of names identifying the keys 208 to be traversed in order to reach either a sub-key 208 or a name 204. For example, referring to FIG. 4A, “DEPARTMENTS/HR/EMPLOYEES/John/title” is a path for the name 204 and 206 value pair 202 defining the job title of John, who is an employee in the HR department. Each of the methods in Table 1 performs a function on an element (key or name and value). Therefore, a path is required so that the SC 514 can locate the element upon which the function is to be performed. In the presently preferred embodiment, no distinction is made between directories, file names, and keys. Therefore, a path suitably includes directory information, file name information, and key information. In the example above, “DEPARTMENTS” references a directory, “HR” references the file “HR.xml” as well as the first key “HR” in the file “HR.xml”, “EMPLOYEES” references a key nested under the “HR” key, and “John” references a key nested under the “EMPLOYEES” key.

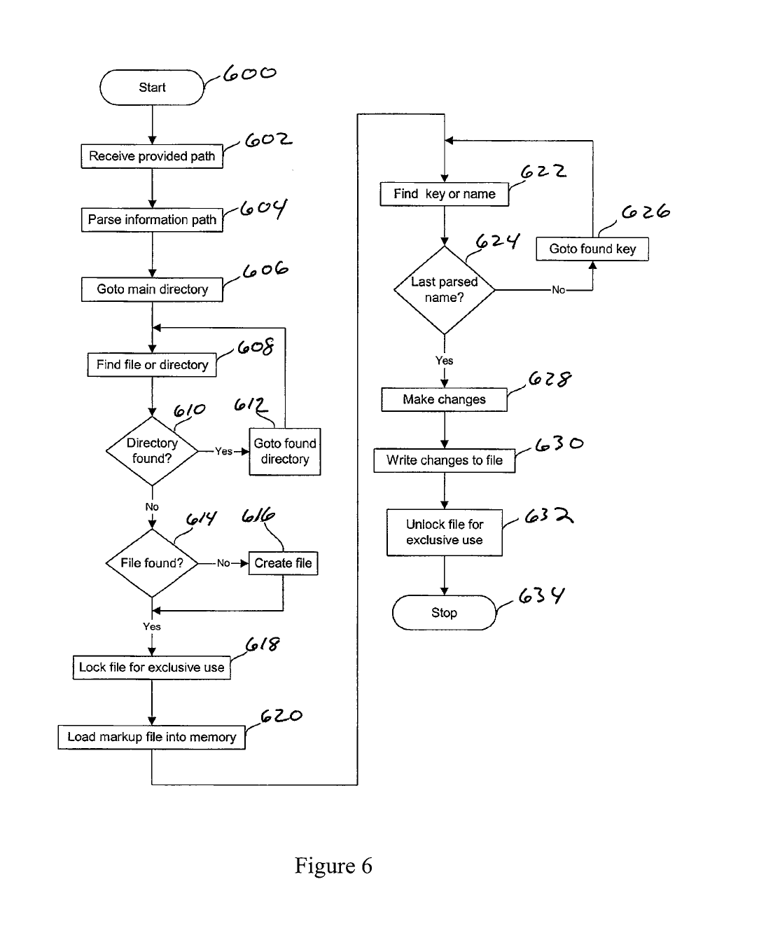

Turning now to FIG. 6, a flowchart generally depicting an example implementation of the method of interfacing with the hierarchical storage system of the present invention is provided. The general flow commences at start block 600, from which flow progresses to process block 602 wherein a provided path is received. The provided path is suitably received from a user, and may be provided through automation. Using the above example, the provided path is suitably represented by “ACME INC.\DEPARTMENTS\HR\”. Flow then progresses to process block 604 wherein the nature of the received path is parsed. After the received path is parsed, the parsed information is suitably used to determine the location of the object upon which a function is to be performed. Flow continues to process block 606 wherein the procedure sets the main directory or root directory as the directory in which a search will be performed. In the example above, the main directory would be “ACME INC.” Progression then flows to process block 608 wherein a search is performed for either a file or directory matching the first parsed name. In the above example, a search within the location “ACME, INC.\” for a file or directory with the name “DEPARTMENTS” is suitably performed.

Progression then flows to decision block 610 wherein a determination is made whether a folder matching the parsed name was found. A positive determination at decision block 610 means that the target folder exists which causes progression to process block 612 wherein the search directory is then set to the found folder. Progression then loops back to process block 608 wherein another search is performed. The new search is preferably performed in the found folder for the parsed name following that matching the found folder. In other words, using the above example, a new search is suitably performed in the location “ACME INC.\DEPARTMENTS\” for a file or folder matching the parsed name “HR”.

A negative determination at decision block 610 causes progression to decision block 614 wherein a determination is made whether a file is found matching the parsed name. A negative determination at decision block 614 causes progression to process block 616 wherein a new markup language based file is created having a name matching the parsed name. In this case, the file would suitably be named “HR.xml”. Progression then continues to process block 618. A negative determination at decision block 614 might also return an error instead of causing a new file to be created in order to more easily maintain data integrity and for the purposes of maintaining user simplicity.

A positive determination at decision block 614 causes progression to process block 618 wherein the found file is preferably locked for exclusive use. Locking the file allows for changes to be made to the file while ensuring integrity of data. Flow then continues to process block 620 wherein the markup based file is loaded into memory. In the presently preferred embodiment, a DOM XML parser is invoked to load the XML file into a memory tree which can then be traversed.

Progression then continues to process block 622 where a search is performed on the memory tree for a key 508 or name 504 matching the next parsed name following the name of the file loaded into memory. Flow continues to decision block 624 wherein a determination is made whether the found key 208 or name 204 is the last parsed name. A negative determination at decision block 624 means that there exists a nested key 208 or name 204 which is the target of any change to be made. Therefore, progression flows to process block 626 wherein the search location is then set to the found key 208 or name 204. Progression then loops back to process block 622 wherein a search is performed for the next parsed name nested within the key 208 or name 204.

A positive determination at decision block 624 means that the key 208 or name 204 which cannot be found within the memory tree is the last parsed name. In other words, the name 204 corresponding to information that is to be changed has been located within the memory tree.

Flow then continues to process block 628 wherein the appropriate changes are made to the memory tree. After making appropriate changes to the memory tree, progression continues to process block 630 wherein the memory tree is written back to the file that was locked for exclusive use in process block 618. Flow then continues to process block 632 wherein the file is unlocked, after which the process terminates at termination block 634.

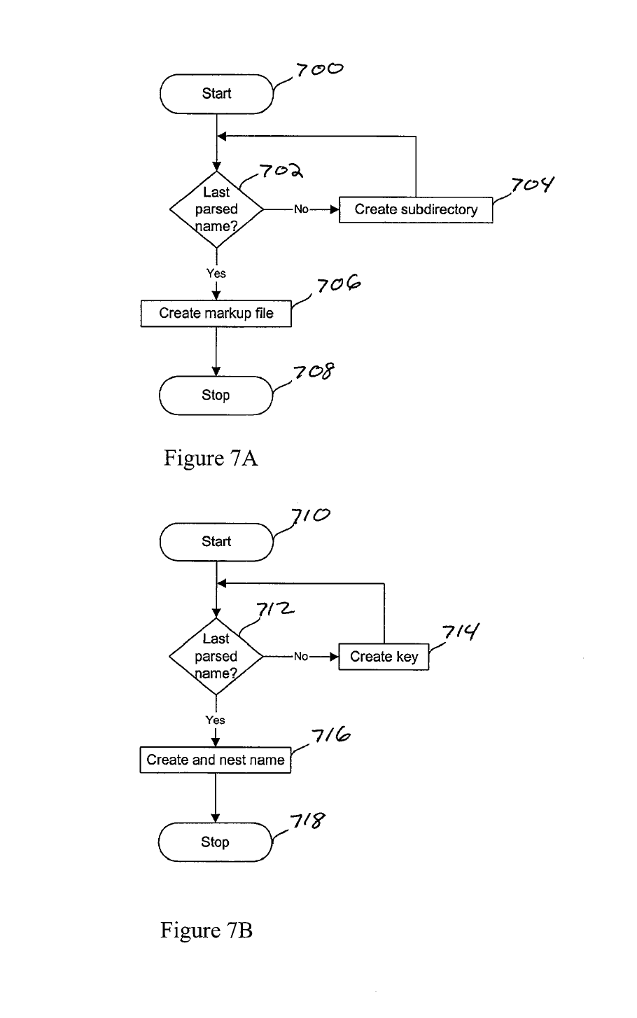

Turning now to FIG. 7A, illustrated is a basic flowchart of a method for creating elements in a hierarchical storage system of the present invention. When parsing the given path and a name in the sequence does not match any existing XML file or directory, a user might wish to add an element to the hierarchical storage system. The basic flow commences at start block 700, from which progression is made to decision block 702. At decision block 702, a determination is made whether the name not matching a file or directory is the last parsed name. A negative determination at decision block 702 means that the search is not complete, causing progression to flow to process block 704 wherein a subdirectory is created. Progression then loops back to decision block 702 wherein a determination is made whether the newly created subdirectory is the last parsed name.

A positive determination at decision block 702 means that the search is complete, causing progression to flow to process block 706 wherein a markup based file is created. In the presently preferred embodiment, an XML file is created. Progression then continues to termination block 708.

Turning now to FIG. 7B, illustrated is a basic flowchart of a method for creating elements in a hierarchical markup language file. When parsing the given path and a name in the sequence does not match any existing XML file or directory, a user might wish to add an element to the XML file. The basic flow commences at start block 710, from which progression is made to process block 712. At process block 712 a new element is created and nested as appropriate. The new element is suitably a key 208 or a name 204. Progression then continues to decision block 712, wherein a determination is made whether the newly created element is the last parsed name. A negative determination at decision block 712 means that the search is not complete, causing progression to loop back to process block 714 wherein another element is created matching the next parsed name.

A positive determination at decision block 712 means that the search is complete, causing progression to flow to process block 714 wherein a new name is created and nested. Flow then progresses to termination block 718.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed is:

1. A multi-level, hierarchical information configuration data storage system employing a markup language linked to a corresponding file system comprising:
a file system based configuration data repository including,
at least one first level folder, represented by a first selected directory area of the file system, for storing at least first and second data sets inclusive of configuration information for an associated document imaging device,
at least one first level markup based data file stored within the at least one first level folder, the first level markup based data file being linked to the first selected directory area and comprising information relative to at least a portion of the first data set,
at least one second level folder, represented by a second selected directory area of the file system, stored within the at least one first level folder for storing information relative to the second data set, and
at least one second level markup based data file stored within the at least one second level folder, the second level markup based data file being linked to the second selected directory area and comprising information relative to at least a portion of the second data set; and
an interface communicatively coupled to the repository for handling communications with the repository, the interface including,
means adapted for outputting the configuration information from the file system to a data format compatible with one of a plurality of different operating systems,
means adapted for selectively locking at least one selected directory area during a modification of a data set corresponding thereto, and
means adapted for communicating output configuration information to a selected one of a plurality of different operating system environments, including an operating system employing hierarchical configuration information storage and an operating system including non-hierarchical configuration information storage.

2. The system of claim 1 wherein the interface comprises computer readable code for providing a functionality selected from the group consisting of: querying the repository, changing the repository structure, adding to the repository, deleting from the repository, and combinations thereof.

3. The system of claim 1 wherein the interface comprises computer readable code for providing a functionality selected from the group consisting of: querying the markup based files, changing the markup based files, adding to the markup based files, deleting from the markup based files, and combinations thereof.

4. The system of claim 1 wherein the interface further comprises computer readable code for ensuring data integrity.

5. The system of claim 1 further comprising at least one software component for performing a function on an element of the repository.

6. The system of claim 1 further comprising at least one software component for performing a function on an element of the repository.

7. The system of claim 1 wherein the markup based files are selected from the group consisting of: SGML, XML, HTML, and combinations thereof.

8. The system of claim 1 wherein the markup based files comprise information stored in a form selected from the group consisting of: unsigned integers, text, binary data, and combinations thereof.

9. The system of claim 1 wherein the markup based files comprise at least one key and at least one name and value pair.

10. The system of claim 9 further comprising at least one software component for performing a function on name and value pairs.

11. The system of claim 10 wherein the function performed by the software component is selected from the group consisting of: querying, creating, modifying, deleting, and combinations thereof.

12. The system of claim 1 comprising a plurality of repositories.

13. A multi-level hierarchical device configuration information storage system in a network environment comprising:
a client communicatively coupled to a server;
at least one file system based configuration data repository stored on the server including:
at least one first level folder for storing at least first and second data sets inclusive of configuration information for an associated document processing device,
at least one first level markup based file stored within the at least one first level folder, the first level markup based file comprising information relative to at least a portion of the first data set,
at least one second level folder stored within the at least one first level folder for storing information relative to the second data set, and
at least one second level markup based file stored within the at least one second level folder, the second level markup based file comprising information relative to at least a portion of the second data set; and
an interface communicatively coupled to the at least one repository for handling communications with the repository, the interface including,
means adapted for outputting the configuration information from the file system to a data format compatible with one of a plurality of different operating systems,
means adapted for selectively locking at least one selected directory area during a modification of a data set corresponding thereto; and
means adapted for communicating output configuration information to a selected one of a plurality of different operating system environments, including an operating system employing hierarchical configuration information storage and an operating system including non-hierarchical configuration information storage.

14. The system of claim 13 wherein the interface is located on the server.

15. The system of claim 13 wherein the interface is located on the client.

16. The system of claim 13 wherein the interface comprises computer readable code for providing a functionality selected from the group consisting of: querying the repository, changing the repository structure, adding to the repository, deleting from the repository, and combinations thereof.

17. The system of claim 13 wherein the interface comprises computer readable code for providing a functionality selected from the group consisting of: querying the markup based files, changing the markup based files, adding to the markup based files, deleting from the markup based files, and combinations thereof.

18. The system of claim 13 wherein the interface further comprises computer readable code for ensuring data integrity.

19. The hierarchical information storage system of claim 13 further comprising at least one software component for performing a function on an element of the repository.

20. The system of claim 19 wherein the at least one software component is located on the server.

21. The system of claim 19 wherein the at least one software component is located on the client.

22. The hierarchical information storage system of claim 19 wherein the function performed by the software component is selected from the group consisting of: querying, creating, modifying, deleting, and combinations thereof.

23. The system of claim 13 wherein the markup based files are selected from the group consisting of: SGML, XML, HTML, and combinations thereof.

24. The system of claim 13 wherein the markup based files comprise information stored in a form selected from the group consisting of: unsigned integers, text, binary data, and combinations thereof.

25. The system of claim 13 wherein the markup based files comprise at least one key and at least one name and value pair.

26. The system of claim 13 comprising a plurality of repositories.

27. A method for accessing device configuration data from a repository, the steps comprising:
receiving a command via an interface communicatively coupled to a file system based configuration data repository specifying a value path;
searching for a file in the repository based on the value path, wherein the repository comprises at least one first level folder, a markup file including at least one first level markup based file inclusive of device configuration data stored within the at least one first level folder, at least one second level folder stored within the at least one first level folder, and at least one second level markup based file inclusive of device configuration data stored within the at least one second level folder, the searching beginning at the first level folder and continuing through additional level folders as necessary until a markup based file is found;
outputting device configuration data from the file system to a data format compatible with one of plurality of different operating systems;
locking the file for exclusive use;
loading the markup file;
finding a key within the markup file; and
communicating device configuration data to a selected one of plurality of different operating system environments, including an operating system employing hierarchical configuration information storage and an operating system including non-hierarchical configuration information storage.

28. The method of claim 27 further comprising:
setting the value of the key within the markup file;
writing the change to the markup file to the repository; and
unlocking the file.

29. A computer-readable medium of instructions, comprising:
means adapted for receiving a command via an interface communicatively coupled to a file system based configuration data repository specifying a value path;
means adapted for searching for a file in the repository based on the value path, wherein the repository comprises at least one first level folder, and a markup file including at least one first level markup based file inclusive of device configuration data stored within the at least one first level folder, at least one second level folder stored within the at least one first level folder, and at least one second level markup based file inclusive of device configuration data stored within the at least one second level folder, the searching beginning at the first level folder and continuing through additional level folders as necessary until a markup based file is found;
means adapted for outputting device configuration data from the file system to a data format compatible with one of plurality of different operating systems;
means adapted for locking the file for exclusive use;
means adapted for loading the markup file;
means adapted for finding a key within the markup file; and
means adapted for communicating device configuration data to a selected one of a plurality of different operating system environments, including an operating system employing hierarchical configuration information storage and an operating system including non-hierarchical configuration information storage.

30. The computer-readable instructions of claim 29 further comprising:
means adapted for setting the value of the key within the markup file;
means adapted for writing the change to the markup file to the repository; and
means adapted for unlocking the file.
